(19) United States
(12) Patent Application Publication
(10) Pub. No.: US 2014/0176019 A1
(43) Pub. Date: Jun. 26, 2014

(54) MOOD LAMP SYSTEM, METHOD OF CONTROLLING MOOD LAMP, AND MOOD LAMP CONTROLLING APPARATUS

(71) Applicants: KIA MOTORS CORPORATION, Seoul (KR); HYUNDAI MOTOR COMPANY, Seoul (KR)

(72) Inventors: Se Min Oh, Seoul (KR); Jinhyun Oh, Hwaseong (KR)

(73) Assignees: KIA MOTORS CORPORATION, Seoul (KR); HYUNDAI MOTOR COMPANY, Seoul (KR)

(21) Appl. No.: 14/102,923

(22) Filed: Dec. 11, 2013

(30) Foreign Application Priority Data
Dec. 20, 2012 (KR) 10-2012-0149952

(51) Int. Cl. H05B 37/02

(52) U.S. Cl. CPC H05B 37/02
USPC 315/308

(57) ABSTRACT

A mood lamp system, a method of controlling a mood lamp, and a mood lamp controlling apparatus that include a mood lamp and a mood lamp controlling apparatus that is configured to select a mode of the mood lamp from a plurality of modes including an off mode, a mood mode, and a music mode. In addition, a mood lamp controller is configured to operate the mood lamp based on the mode of the mood lamp. The mood lamp may emit light of a single color in the music mode.

### CROSS-REFERENCE TO RELATED APPLICATION

This application claims priority to and the benefit of Korean Patent Application No. 10-2012-0149952 filed in the Korean Intellectual Property Office on Dec. 20, 2012, the entire contents of which are incorporated herein by reference.

### BACKGROUND

(a) Field of the Invention

The present invention relates to a mood lamp system, a method of controlling a mood lamp, and a mood lamp controlling apparatus, and more particularly, to a mood lamp system, a method of controlling a mood lamp, and a mood lamp controlling apparatus capable of improving characteristics of a typical mood lamp.

(b) Description of the Related Art

As vehicle and electronic technologies develop, various new apparatuses are mounted within a vehicle. For example, a mood lamp capable of changing a gloomy mood of a driver is one of the additional functions of the new apparatuses. In particular, since a color and illuminance are controlled in a mood mode and a music mode of the mood lamp, a structure of the mood lamp and a method of controlling the mood lamp are complicated. Therefore, efficiency of the mood lamp may deteriorate. Particularly, when a color changes in the music mode, it may be difficult for a user to recognize a difference in music.

The above information disclosed in this section is only for enhancement of understanding of the background of the invention and therefore it may contain information that does not form the prior art that is already known in this country to a person of ordinary skill in the art.

### SUMMARY

An exemplary embodiment of the present invention provides a mood lamp system, a method of controlling a mood lamp, and a mood lamp controlling apparatus capable of simplifying a structure and a control and increasing user satisfaction.

A mood lamp system according to an exemplary embodiment of the present invention may include a mood lamp, a mood lamp controlling apparatus that includes a mode selecting unit for selecting a mode of the mood lamp including an off mode, a mood mode, and a music mode, and a mood lamp controller that controls the mood lamp based on the mode of the mood lamp. In addition, the mood lamp may emit light of a single color in the music mode.

The mood lamp controlling apparatus may further include an illuminance controller that operates illuminance of the mood lamp and may include the mode selecting unit and the illuminance controller.

The mood lamp system may further include an audio signal obtaining unit that receives an audio signal of a vehicle. The mood lamp controller may operate illuminance of the mood lamp based on the audio signal obtaining unit in the music mode. In addition, the mood lamp controller may change a color of the mood lamp in a predetermined period in the mood mode.

A method of controlling a mood lamp according to an exemplary embodiment of the present invention may include selecting one of a plurality of mood lamp modes including an off mode, a mood mode, and a music mode and operating the mood lamp based on a mode of the mood lamp. In addition, the mood lamp may be turned off in the off mode. Illuminance and a color of the mood lamp may be operated in the mood mode. Further, the mood lamp may emit light of a single color in the music mode to operate illuminance by sound pressure. A color of the mood lamp may be changed in a predetermined period in the mood mode.

A mood lamp controlling apparatus according to an exemplary embodiment of the present invention may include a mode selecting unit for selecting a mode of a mood lamp as one of an off mode, a music mode, and a mood mode by reciprocating and rotating an off mode region, a music mode region, and a mood mode region and an illuminance controller positioned in the mode selecting unit to operate illuminance of the mood lamp by the number of pushes of the mood mode. In addition, the mood lamp controlling apparatus may be formed of the mode selecting unit and the controller. The illuminance controller may be divided into two regions to allow one region to be used for increasing illuminance and the other region to be used for reducing illuminance.

### BRIEF DESCRIPTION OF THE DRAWINGS

FIG. 1 is an exemplary block diagram of a mood lamp system according to an exemplary embodiment of the present invention;

FIG. 2 is an exemplary view describing a mood lamp controller of a mood lamp system according to an exemplary embodiment of the present invention changing a color in a mood mode;

FIG. 3 is an exemplary flowchart illustrating a method of controlling a mood lamp using a mood lamp system according to an exemplary embodiment of the present invention; and

FIG. 4 is an exemplary top plan view illustrating a mood lamp controlling apparatus of a mood lamp system according to an exemplary embodiment of the present invention.

### DESCRIPTION OF SYMBOLS

100: mood lamp system

10: mood lamp

20: mood lamp controlling apparatus

30: mood lamp controller

40: audio signal obtaining unit

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an exemplary embodiment of the present invention will be described in detail with reference to the accompanying drawings. However, the present invention is not limited to the exemplary embodiment but various modifications may be made.

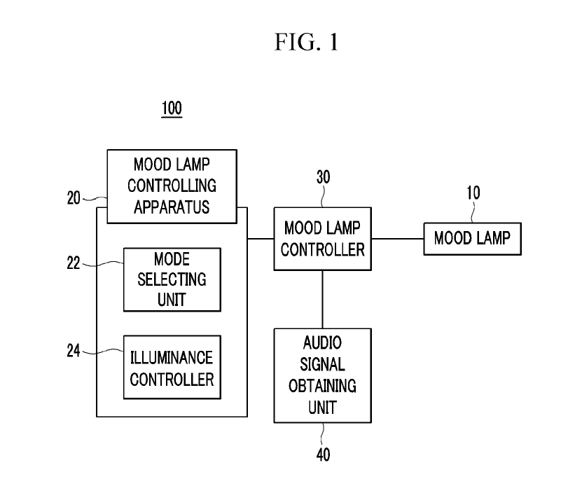

FIG. 1 is an exemplary block diagram of a mood lamp system according to an exemplary embodiment of the present invention. As illustrated in FIG. 1, a mood lamp system 100 within a vehicle according to an exemplary embodiment of the present invention may include a mood lamp 10, a mood lamp controlling apparatus 20, and a mood lamp controller 30. For an operation of the mood lamp controller 30, an audio signal obtaining unit 40 configured to receive a necessary audio signal may be further included.

The mood lamp 10 may include a plurality of light emitting devices that emit light components of different colors. For example, the light emitting device may include a light emitting diode (LED) and the plurality of light emitting devices may include a red light emitting device, a green light emitting device, and a blue light emitting device. However, the present invention is not limited thereto. Therefore, other light emitting devices than the LED may be used. The plurality of light emitting devices may include a plurality of light emitting devices of a different combination from that of the red, green, and blue light emitting devices.

The audio signal obtaining unit 40 may include a filter to receive various audio signals output from an audio apparatus provided within a vehicle. Audio signals only in a specific band may be obtained. The audio signal obtaining unit 40 may further include frequency filters of low, intermediate, and high bands based on user preference. When necessary, the obtained various audio signals may be amplified and compensated for.

The mood lamp controlling apparatus 20 according to the present exemplary embodiment may include a mode selecting unit 22, executed by the mood lamp controlling apparatus 20, configured to select a mode. The mode selecting unit 22 may be configured to select a mode of the mood lamp 10 including an off mode, a mood mode, and a music mode. The mood lamp controlling apparatus 20 may further include an illuminance controller 24 configured to select illuminance of the mood lamp 10. However, the present invention is not limited thereto. The mood lamp controlling apparatus 20 may not include the illuminance controller 24 but the illuminance of the mood lamp 10 may be controlled to be interlocked with another lamp within the vehicle. In other words, the mood lamp controlling apparatus 20 according to the present exemplary embodiment may be formed of only the mode selecting unit 22 or the mode selecting unit 22 in combination with the illuminance controller 24.

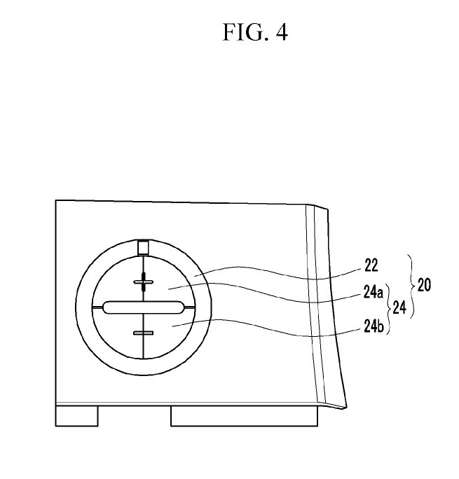

Furthermore, the mood lamp controlling apparatus 20 may be disposed within the vehicle in the form of a button that may be manipulated by the user, which will be described more fully with reference to FIG. 4. The mood lamp controlling apparatus 20 may optionally not additionally include a color selecting unit for selecting a color to reduce cost of the apparatus. In addition, the color selecting unit may not be included since a change in sound may be recognized in the music mode when a single color rather than various colors is applied. The above will be later described in detail.

The mood lamp controller 30 may be configured to operate the illuminance and/or color of the mood lamp based on the mode of the mood lamp 10. In the off mode, the mood lamp controller 30 may be configured to turn off the mood lamp 10.

In the mood mode, the mood lamp controller 30 may be configured to operate the illuminance of the mood lamp 10 via the illuminance controller 24 or to be interlocked with the lamp within the vehicle. The mood lamp controller 30 may be configured to combine the plurality of light emitting devices of the mood lamp 10 to operate the color of the mood lamp 10. In an exemplary embodiment, in the mood mode, the mood lamp 10 may be changed in a uniform period to emit green, blue-green, blue, pink, red, and yellow light components. In addition, the color of the mood lamp 10 may be changed in a uniform period via a pulse width modulation (PWM).

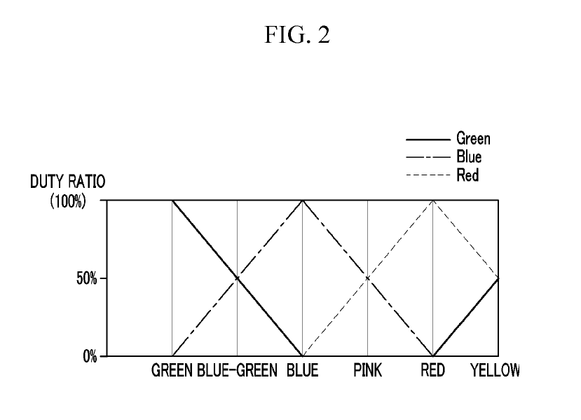

For example, as illustrated in FIG. 2, a duty ratio of the red light emitting device, a duty ratio of the green light emitting device, and a duty ratio of the blue light emitting device may be operated to emit light components of various colors. In other words, red light may be emitted when the duty ratio of the red light emitting device is 100%, green light may be emitted when the duty ratio of the green light emitting device is 100%, and blue light may be emitted when the duty ratio of the blue light emitting device is 100%. When the duty ratio of the red light emitting device and the duty ratio of the green light emitting device exist in a uniform ratio, yellow light may be emitted. When the duty ratio of the green light emitting device and the duty ratio of the blue light emitting device exist in a uniform ratio, blue-green light may be emitted. When the duty ratio of the blue light emitting device and the duty ratio of the red light emitting device exist in a uniform ratio, pink light may be emitted. Other than the above, light components of various colors may be emitted by combinations of the red, green, and blue light emitting devices.

In the music mode, the mood lamp controller 30 may be configured to operate the illuminance of the mood lamp 10 based on a voltage (i.e., sound pressure) of an audio signal received by the audio signal obtaining unit 40. In addition, the PWM may be used as a signal for operating the mood lamp 10. In the music mode of the present exemplary embodiment, light of a single color may be emitted since the mood lamp controlling apparatus 20 does not include the color selecting unit. The color in the music mode may be interlocked with another lamp within the vehicle or may be predetermined as a uniform color, e.g., red. The color in the music mode may be changed by tuning.

As described above, in the present exemplary embodiment, the mood lamp controlling apparatus 20 does not include the color selecting unit, and thus, the mood lamp 10 emits light of a single color in the music mode. Therefore, a structure of the mood lamp controlling apparatus 20 may be simplified and a structure of the mood lamp controller 30 that operates the mood lamp may be also simplified. In addition, the mood lamp emits light of a single color so that the user may easily sense a change in sound pressure. Therefore, satisfaction of the user may be increased.

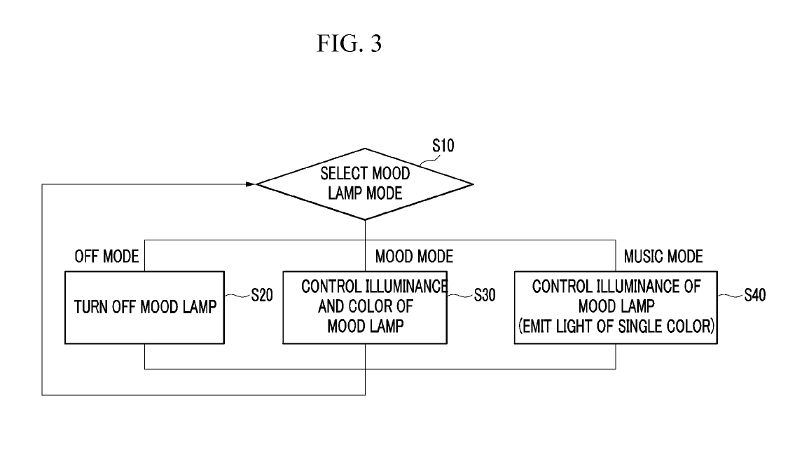

FIG. 3 is an exemplary flowchart illustrating a method of controlling a mood lamp using a mood lamp system according to an exemplary embodiment of the present invention.

A user may select a mood mode include the off mode, the mood mode, and the music mode using the mode selecting unit 22 of the mood mode controlling apparatus 20 S10. In the off mode, the mood lamp controller 30 may be configured to turn off the mood lamp 10 S20. In the mood mode, the mood lamp controller 30 may be configured to operate the illuminance and color of the mood lamp 10 S30. In other words, the mood lamp controller 30 may be configured to combine a plurality of light emitting devices to operate the color of the mood lamp 10. For example, the mood lamp 10 may be changed in a uniform period to emit green, blue-green, blue, pink, red, and yellow light components. The mood lamp controller 30 may be configured to operate the illuminance of the mood lamp 10 by the illuminance controller 24 or to be interlocked with a lamp within a vehicle. In the music mode, the mood lamp controller 30 may be configured to operate the illuminance of the mood lamp 10 based on sound pressure S30. In addition, the mood lamp 10 may emit light of a single color. Therefore, the illuminance and/or color of the mood lamp 10 may be operated to change the mood to help safe driving.

Hereinafter, an example of the above-described mood lamp controlling apparatus 20 will be described more fully with reference to FIG. 4. FIG. 4 is an exemplary top plan view illustrating a mood lamp controlling apparatus of a mood lamp system according to an exemplary embodiment of the present invention. As illustrated in FIG. 4, the mode selecting unit 22 of the mood lamp controlling apparatus 20 may be a switch that reciprocates and rotates in an off mode region, a music mode region, and a mood mode region. The mode selecting unit 22 having a circular shape may be positioned to form an exterior of the mood lamp controlling apparatus 20. The off mode, the music mode, and the mood mode may be selected by a rotation of the mode selecting unit 22.

The illuminance controller 24 as a push type button may have, for example, a circular shape in the mode selecting unit 22. In particular, the illuminance controller 24 may be divided into two regions 24a and 24b to allow the region 24a (for example, a region positioned in an upper portion) to be used as a button for increasing illuminance and the other region 24b (for example, a region positioned in a lower portion) to be used as a button for reducing illuminance. However, the present invention is not limited thereto but the illuminance controller 24 may be divided into no less than three regions. Alternately, the illuminance controller 24 may be omitted in the mood lamp controlling apparatus 20.

The above-structured mood lamp controlling apparatus 20 is disclosed as an example and the present invention is not limited thereto.

In the mood lamp system according to the exemplary embodiment of the present invention, the mood lamp controlling apparatus does not include the color selecting unit and thus, the mood lamp emits light of a single color in the music mode. Therefore, the structure of the mood lamp controlling apparatus may be simplified and the structure of the mood lamp controller for operating the mood lamp may be also simplified. In addition, the mood lamp emits light of a single color and thus, the user may easily sense the change in sound pressure. Therefore, satisfaction of the user may be increased.

The above-described characteristic, structure, and effect are included in at least one exemplary embodiment of the present invention and are not limited to only one exemplary embodiment. Furthermore, the characteristic, structure, and effect illustrated in the respective exemplary embodiments may be combined or modified to be applied to other exemplary embodiments by those skilled in the art. Therefore, it is to be interpreted that contents related to the combinations and modifications are included in the scope of the present invention.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A mood lamp system, comprising:
a mood lamp;
a mood lamp controlling apparatus configured to select a mode of the mood lamp from a plurality of modes including an off mode, a mood mode, and a music mode; and
a mood lamp controller configured to operate the mood lamp based on the mode of the mood lamp,
wherein the mood lamp emits light of a single color in the music mode.

2. The mood lamp system of claim 1, wherein the mood lamp controlling apparatus further comprises an illuminance controller configured to operate illuminance of the mood lamp.

3. The mood lamp system of claim 1, wherein the mood lamp controller is further configured to:
obtain an audio signal of a vehicle; and
operate illuminance of the mood lamp based on the obtained audio signal in the music mode.

4. The mood lamp system of claim 1, wherein the mood lamp controller is further configured to change a color of the mood lamp in a predetermined period in the mood mode.

5. A method of controlling a mood lamp, comprising:
selecting, by a mood lamp controller, one of a plurality of mood lamp modes including an off mode, a mood mode, and a music mode; and
operating, by the mood lamp controller, the mood lamp based on a mode of the mood lamp,
wherein the mood lamp is turned off in the off mode,
wherein illuminance and a color of the mood lamp are operated in the mood mode, and
wherein the mood lamp emits light of a single color in the music mode to operate illuminance by sound pressure.

6. The method of claim 5, wherein a color of the mood lamp is changed in a predetermined period in the mood mode.

7. A mood lamp controlling apparatus, comprising:
a controller configured to:
select a mode of a mood lamp including an off mode, a music mode, and a mood mode by reciprocating and rotating an off mode region, a music mode region, and a mood mode region; and
operate illuminance of the mood lamp by the number of pushes of the apparatus.

8. The mood lamp controlling apparatus of claim 7, wherein the controller is divided into two regions and one region is used for increasing illuminance and the other region is used for reducing illuminance.

9. A mood lamp controlling apparatus, comprising:
a mood lamp;
a controller configured to:
obtain an audio signal of a vehicle;
select a mode of a mood lamp including an off mode, a music mode, and a mood mode by reciprocating and rotating an off mode region, a music mode region, and a mood mode region; and
operate illuminance of the mood lamp by the number of pushes of the apparatus.

10. The mood lamp controlling apparatus of claim 9, wherein the controller is further configured to:
operate illuminance of the mood lamp based on the obtained audio signal in the music mode.

11. The mood lamp controlling apparatus of claim 9, wherein the controller is further configured to:
change a color of the mood lamp in a predetermined period in the mood mode.
